(19) United States
(12) Patent Application Publication
(10) Pub. No.: US 2007/0097224 A1
(43) Pub. Date: May 3, 2007

(54) Camera system

(75) Inventor: Kazuhiro Haneda, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/586,416

(22) Filed: Oct. 25, 2006

(30) Foreign Application Priority Data
Nov. 2, 2005 (JP) 2005-319259

(51) Int. Cl. H04N 5/235

(52) U.S. Cl. 348/221.1

(57) ABSTRACT

A camera system includes a synchronization signal generator and a camera device separated from the synchronization signal generator. The synchronization signal generator generates a subframe synchronization signal having a constant period and a variable-frame synchronization signal having a variable period. The camera device further includes an internal synchronization signal generating unit that generates an internal synchronization signal; a phase adjusting unit that adjusts a phase of the internal synchronization signal so as to match a phase the subframe synchronization signal with a phase of the internal synchronization signal; and a synchronization signal selecting unit that selects the variable-frame synchronization signal as a synchronization signal to be used for picking up an image if the subframe synchronization signal corresponds in phase to the internal synchronization signal.

### BACKGROUND OF THE INVENTION

1. Field of the Invention

The present invention generally relates to a camera system. More specifically, the present invention relates to a camera system for controlling one or more camera devices configured to pick up image at a variety of frame rates, wherein the control is made by using a synchronization signal that has been generated in the outside of the camera device.

Priority is claimed on Japanese Patent Application No. 2005-319259, filed Nov. 2, 2005, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

A conventional technique has been established to select one of plural images obtained by plural cameras and display the selected one image on a display device. Typical examples of the conventional technique may be a live relay system and a monitoring camera system. Another conventional technique has been established to edit and synthesize original images to prepare a set of contents, the original images having been obtained by a plurality of cameras. For example, a three-dimensional image pickup system uses a pair of right-eye and left-eye cameras to prepare a three-dimensional image. In those conventional techniques, a plurality of cameras are jointly controlled to match the timings of picking up the images in order to display or synthesize image contents smoothly and continuously over times.

The plurality of cameras is controlled so as to match the frame rates and the phases thereof thereby matching the timings of picking up images. For example, an external synchronization signal can be inputted into the plurality of cameras. The external synchronization signal provides a reference that is equivalent to the frame rate at which the plurality of cameras picks up images. Each of the plurality of cameras includes a synchronous coupling circuit that receives the external synchronization signal. The synchronous coupling circuit generates an internal synchronization signal that has a frame rate and a phase, wherein the frame rate and the phase are synchronized with the received external synchronization signal. The timing of picking up image is controlled based on the internal synchronization signal thereby obtaining the image that is synchronized with the external synchronization signal. Thus, the external synchronization signal can be used to control the plurality of cameras so as to match the timings of picking up images.

Japanese Unexamined Patent Application, First Publication, No. 61-141267 discloses a conventional configuration of the synchronous coupling circuit integrated on the conventional camera. FIG. 9 is a block diagram illustrating the conventional configuration of the synchronous coupling circuit integrated on the conventional camera. A synchronous coupling circuit 9 is integrated in the camera. The synchronous coupling circuit 9 can be realized by a phase locked loop circuit. A reference signal generating circuit 1 in the outside of the camera generates an external synchronization signal 2. The synchronous coupling circuit 9 receives the external synchronization signal 2 from the reference signal generating circuit 1. The synchronous coupling circuit 9 includes a phase comparing circuit 3, a smoothing and amplifying circuit 5, a voltage controllable oscillator (VOC) 6, and a frequency-dividing circuit 7.

The phase comparing circuit 3 receives the external synchronization signal 2 from the reference signal generating circuit 1. The phase comparing circuit 3 also receives an internal synchronization signal 3 that has been generated in the inside of the camera. The phase comparing circuit 3 compares a phase of the external synchronization signal 2 and a phase of the internal synchronization signal 8 and generates a phase comparison result 4. The smoothing and amplifying circuit 5 receives the phase comparison result 4 from the phase comparing circuit 3. The smoothing and amplifying circuit 5 converts the phase comparison result 4 into a smoothed direct current voltage signal and amplifies the smoothed direct current voltage signal. The voltage controllable oscillator (VCO) 6 receives the amplified smoothed direct current voltage signal from the smoothing and amplifying circuit 5.

FIG. 10 is a diagram illustrating waveforms of the external synchronization signal, the internal synchronization signal, and the phase comparison result. The phase comparing circuit 3 receives the external synchronization signal 2 and the internal synchronization signal 8 and generates the phase comparison result 4. The phase of the output signal from the voltage controllable oscillator VCO6 is controlled based on the phase comparison result 4.

The frequency-dividing circuit 7 receives the phase-controlled output signal from the voltage controllable oscillator VCO6. The frequency-dividing circuit 7 divides a frequency of the phase-controlled output signal and generates the internal synchronization signal 8. The internal synchronization signal 8 is then inputted into the phase comparing circuit 3. The above described set of operations of the synchronous coupling circuit 9 is performed to reduce the phase difference between the external synchronization signal 2 and the internal synchronization signal 8. The operations of the synchronous coupling circuit 9 will be repeated until the external synchronization signal 2 corresponds in phase to the internal synchronization signal 8. The control to the timing of picking up images of the plurality of cameras is performed by the synchronous coupling circuit 9.

Japanese Unexamined Patent Application, First Publication, No. 4-252584 discloses another conventional technique for selecting one of the external synchronization signal and the internal synchronization signal so that only the selected one is used. A switching can be performed between the external synchronization signal and the internal synchronization signal. The other conventional technique does not use any external synchronous coupling circuit. An input image signal can have a predetermined frame rate. A processing for the input image signal with the predetermined frame rate is performed by a frame-synchronous control that uses an internal synchronization signal with the predetermined frame rate. The input signal can also have a frame rate different from the predetermined frame rate. Another processing for the input signal with the different frame rate is performed by using the external synchronization signal thereby realizing the intended image processing for the input image signal with the different frame rate.

In recent years, a camera to be used for producing an image for television or film has been developed. This camera is configured to vary the frame rate while picking up images so as to provide special effects to the image. If the frame rate of the image pickup signal is higher than a frame rate of a reproduction signal, then a slow reproduction of the image is made at the frame rate of the reproduction signal. If the frame rate of the image pickup signal is lower than a frame rate of a reproduction signal, then a fast reproduction of the image is made at the frame rate of the reproduction signal. The camera is configured to allow an operator or user to set an optional frame rate or to change the frame rate optionally. In every frame, a frame rate can optionally be selected. In other words, the frame rate is different between in the different frames. Depending on the use, the plurality of those cameras should be controlled to synchronize the respective timings of picking up images.

In view of the above, it will be apparent to those skilled in the art from this disclosure that there exists a need for an improved camera system. This invention addresses this need in the art as well as other needs, which will become apparent to those skilled in the art from this disclosure.

### SUMMARY OF THE INVENTION

In accordance with a first aspect of the present invention, a camera system includes a synchronization signal generator, and at least a camera device. The synchronization signal generator further includes a first clock generating unit, and an internal synchronization signal generating unit. The first clock generating unit is configured to generate a first reference clock signal. The internal synchronization signal generating unit is configured to divide a frequency of the first reference clock signal. The internal synchronization signal generating unit is configured to generate a subframe synchronization signal having a constant period and a variable-frame synchronization signal having a variable period. The camera device further includes a second clock generating unit, an internal synchronization signal generating unit, a first phase adjusting unit, and a synchronization signal selecting unit. The second clock generating unit is configured to generate a second reference clock signal. The internal synchronization signal generating unit is configured to divide a frequency of the second reference clock signal. The internal synchronization signal generating unit is configured to generate an internal synchronization signal. The first phase adjusting unit is configured to adjust at least one of a phase of the second reference clock signal and a phase of the internal synchronization signal so that the subframe synchronization signal corresponds in phase to the internal synchronization signal. The synchronization signal selecting unit is configured to select the variable-frame synchronization signal as a synchronization signal to be used for picking up an image if the subframe synchronization signal corresponds in phase to the internal synchronization signal.

Preferably, the first phase adjusting unit may include a phase comparing circuit, and a smoothing and amplifying circuit. The phase comparing circuit compares a phase of the subframe synchronization signal with a phase of the internal synchronization signal. The smoothing and amplifying circuit converts an output from the phase comparing circuit into a smoothed direct current voltage signal. The smoothing and amplifying circuit amplifies the smoothed direct current voltage signal. The second clock generating unit may include a voltage controllable oscillator being controlled by an output signal from the smoothing and amplifying circuit.

Preferably, the synchronization signal generator may be a single synchronization signal generator and the camera device may be a plurality of camera devices. In this case, each of the plurality of camera devices may further include a second phase adjusting unit configured to adjust a phase difference between the subframe synchronization signal and the variable-frame synchronization signal.

Preferably, the second phase adjusting unit included in one of the plurality of camera devices can be configured to adjust the phase difference so that a delay of the variable-frame synchronization signal that has been input into the one of the plurality of camera devices is equal to the largest one of the delays of the variable-frame synchronization signals that have been input into the plurality of camera devices.

Preferably, the synchronization signal generator may be a single synchronization signal generator and the camera device may be a plurality of camera devices. In this case, the camera system may further include a separate phase adjusting unit configured to adjust a phase difference between the subframe synchronization signal and the variable-frame synchronization signal for each of the plurality of camera devices separately. The separate phase adjusting unit is configured to supply the adjusted phase difference to each of the plurality of camera devices separately.

These and other objects, features, aspects, and advantages of the present invention will become apparent to those skilled in the art from the following detailed descriptions taken in conjunction with the accompanying drawings, illustrating the embodiments of the present invention.

In accordance with a second aspect of the present invention, a camera system includes a synchronization signal generator that generates a subframe synchronization signal having a constant period and a variable-frame synchronization signal having a variable period; and a camera device being separated from the synchronization signal generator. The camera device further includes: an internal synchronization signal generating unit that generates an internal synchronization signal; a phase adjusting unit that adjusts a phase of the internal synchronization signal so as to match a phase the subframe synchronization signal with a phase of the internal synchronization signal; and a synchronization signal selecting unit that selects the variable-frame synchronization signal as a synchronization signal to be used for picking up an image if the subframe synchronization signal corresponds in phase to the internal synchronization signal.

### BRIEF DESCRIPTION OF THE DRAWINGS

Referring now to the attached drawings which form a part of this original disclosure:

FIG. 1 is a block diagram illustrating a configuration of a camera system in accordance with a first preferred embodiment of the present invention;

FIG. 2 is a block diagram illustrating an internal configuration of the synchronization signal generator that is included in the camera system shown in FIG. 1;

FIG. 3 is a timing chart illustrating waveforms of an external subframe synchronization signal, and an internal subframe synchronization signal in the camera system in accordance with the first preferred embodiment of the present invention;

FIG. 4 is a timing chart illustrating waveforms of first and second reference clocks, the variable-frame synchronization signal, the subframe synchronization signal, and the internal synchronization signal in the camera system in accordance with the first preferred embodiment of the present invention;

FIG. 5 is a block diagram illustrating a configuration of the camera system in accordance with a second embodiment of the present invention;

FIG. 6 is a timing chart illustrating waveforms of the subframe synchronization signal and the variable-frame synchronization signals in the camera system in accordance with the second embodiment of the present invention;

FIG. 7 is a block diagram illustrating a configuration of the camera system in accordance with the third embodiment of the present invention;

FIG. 8 is a block diagram illustrating a configuration of the synchronization signal generator included in the camera system shown in FIG. 7;

FIG. 9 is a block diagram illustrating the conventional configuration of the synchronous coupling circuit integrated on the conventional camera; and

FIG. 10 is a diagram illustrating waveforms of the external synchronization signal, the internal synchronization signal, and the phase comparison result.

### DETAILED DESCRIPTION OF THE INVENTION

Selected embodiments of the present invention will now be described with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

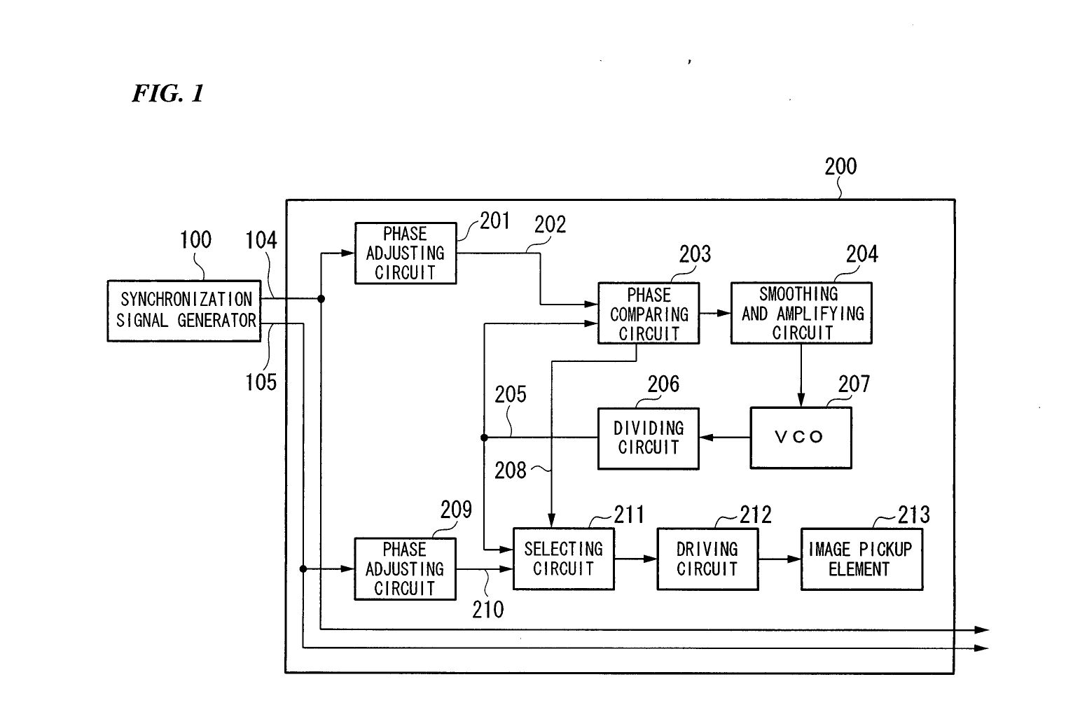

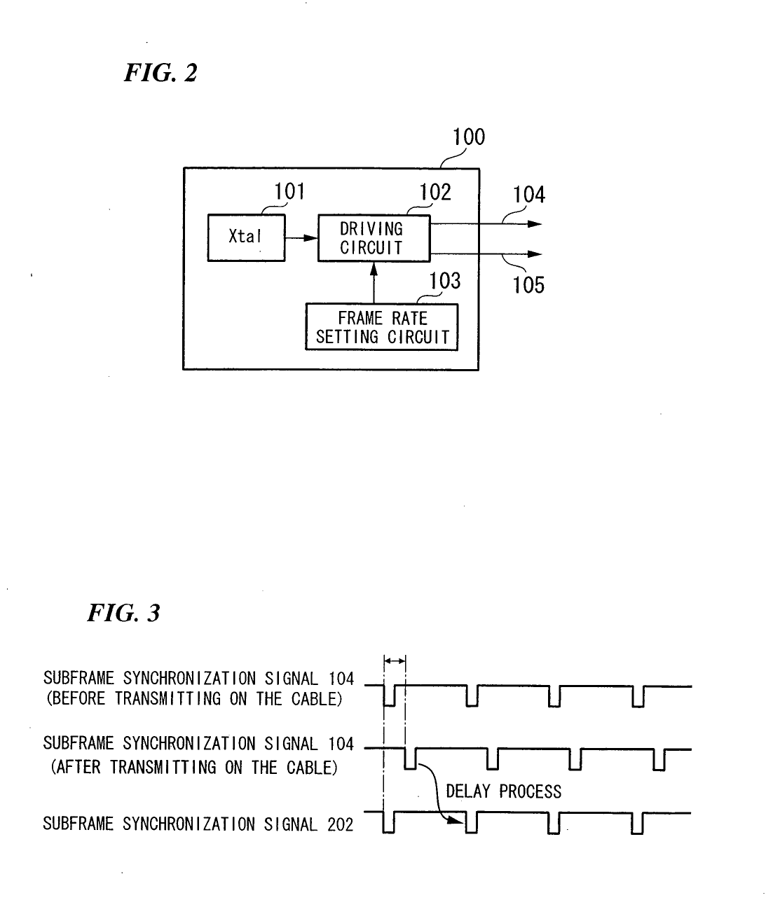

A first embodiment of the present invention will be described with reference to the drawings. FIG. 1 is a block diagram illustrating a configuration of a camera system in accordance with a first preferred embodiment of the present invention. In FIG. 1, a camera system may include, but is not limited to, a synchronization signal generator 100 and a camera device 200. The synchronization signal generator 100 is provided in the outside of the camera device 200. The camera device 200 is functionally coupled to the synchronization signal generator 100. The synchronization signal generator 100 is configured to generate a subframe synchronization signal 104 and a variable-frame synchronization signal 105 as external synchronization signals. FIG. 2 is a block diagram illustrating an internal configuration of the synchronization signal generator 100 that is included in the camera system shown in FIG. 1.

In FIG. 1, the camera device 200 may include, but is not limited to, a second clock generating unit, an internal synchronization generating unit, a first phase adjusting unit, and a synchronization signal selecting unit. The second clock generating unit is configured to generate a second reference clock signal. The second reference clock signal performs as a system clock for the camera device 200. The internal synchronization generating unit is functionally coupled to the second clock generating unit to receive the second reference clock signal from the second clock generating unit. The internal synchronization generating unit is configured to divide the frequency of the second reference clock signal, thereby generating an internal synchronization signal.

The first phase adjusting unit is functionally coupled to the synchronization signal generator 100 to receive the subframe synchronization signal from the synchronization signal generator 100. The first phase adjusting unit is functionally coupled to the internal synchronization generating unit to receive an internal synchronization signal from the internal synchronization generating unit. The first phase adjusting unit is functionally coupled to the second clock generating unit to receive the second reference clock signal from the second clock generating unit. The first phase adjusting unit is configured to adjust the second reference clock signal and/or the internal synchronization signal so that the subframe synchronization signal corresponds in phase to the internal synchronization signal.

The synchronization signal selecting unit is functionally coupled to the synchronization signal generator 100 to receive the variable-frame synchronization signal from the synchronization signal generator 100. The synchronization signal selecting unit is configured to select the variable-frame synchronization signal as a synchronization signal to be used for picking up images if the subframe synchronization signal corresponds in phase to the internal synchronization signal.

The first phase adjusting unit can be realized by, but is not limited to, a phase comparing circuit 203 and a smoothing and amplifying circuit 204. The phase comparing circuit 203 is configured to compare a phase of a subframe synchronization signal 202 to a phase of an internal synchronization signal 205. The phase comparing circuit 203 is configured to generate a phase comparison result that indicates whether or not the subframe synchronization signal 202 corresponds in phase to the internal synchronization signal 205. The phase comparison result may be a phase lock signal 208. The smoothing and amplifying circuit 204 is functionally coupled to the phase comparing circuit 203 to receive the phase lock signal as the phase comparison result from the phase comparing circuit 203. The smoothing and amplifying circuit 204 is configured to convert the phase comparison result into a smoothed direct current voltage and amplify the smoothed direct current voltage.

The second clock generating unit can be realized by, but is not limited to, a voltage controllable oscillator (VCO) 207. The voltage controllable oscillator (VCO) 207 is functionally coupled to the smoothing and amplifying circuit 204 to receive the output signal from the smoothing and amplifying circuit 204. The voltage controllable oscillator (VCO) 207 is configured to generate the second reference clock signal.

The internal synchronization generating unit can be realized by, but is not limited to, a frequency-dividing circuit 206. The frequency-dividing circuit 206 is functionally coupled to the voltage controllable oscillator (VCO) 207 to receive the second reference clock signal from the voltage controllable oscillator (VCO) 207. The frequency-dividing circuit 206 is configured to divide the frequency of the second reference clock signal to generate the internal synchronization signal 205.

The synchronization signal selecting unit can be realized by, but is not limited to, a selecting circuit 211. The selecting circuit 211 is functionally coupled to the phase comparing circuit 203 to receive the phase comparison result from the phase comparing circuit 203. As described above, the phase comparison result indicates whether or not the subframe synchronization signal 202 corresponds in phase to the internal synchronization signal 205. The selecting circuit 211 is functionally coupled to the frequency-dividing circuit 206 to receive the internal synchronization signal 205 from the frequency-dividing circuit 206. The selecting circuit 211 also receives a variable-frame synchronization signal 210. The selecting circuit 211 is configured to select, based on the phase comparison result, one of the variable-frame synchronization signal 210 and the internal synchronization signal 205 as a synchronization signal to be used for picking up images. The selecting circuit 211 is configured to select the variable-frame synchronization signal 210 as a synchronization signal to be used for picking up images, if the phase comparison result indicates that the subframe synchronization signal 202 corresponds in phase to the internal synchronization signal 205.

The camera device 200 may further include a second phase adjusting unit. The second phase adjusting unit is functionally coupled to the synchronization signal generator 100 to receive a subframe synchronization signal 104 and a variable-frame synchronization signal 105 as external synchronization signals. The second phase adjusting unit is configured to adjust a phase difference between the subframe synchronization signal 104 and the variable-frame synchronization signal 105.

The second phase adjusting unit can be realized by, but is not limited to, phase adjusting circuits 201 and 209. The phase adjusting circuit 201 is functionally coupled to the synchronization signal generator 100 to receive the subframe synchronization signal 104 as an external synchronization signal from the synchronization signal generator 100. The phase adjusting circuit 201 is configured to adjust the phase of the subframe synchronization signal 104 as an external synchronization signal so as to generate the subframe synchronization signal 202 as an internal synchronization signal. The phase comparing circuit 203 is functionally coupled to the phase adjusting circuit 201 to receive the subframe synchronization signal 202. The phase comparing circuit 203 is functionally coupled to the frequency-dividing circuit 206 to receive the internal synchronization signal 205 from the frequency-dividing circuit 206. As described above, the phase comparing circuit 203 is configured to compare the phase of the subframe synchronization signal 202 with the phase of the internal synchronization signal 205.

The phase adjusting circuit 209 is functionally coupled to the synchronization signal generator 100 to receive the variable-frame synchronization signal 105 as an external synchronization signal. The phase adjusting circuit 209 is configured to adjust the phase of the variable-frame synchronization signal 105 as an external synchronization signal so as to generate the variable-frame synchronization signal 210 as an internal synchronization signal. The selecting circuit 211 is functionally coupled to the phase adjusting circuit 209 to receive the variable-frame synchronization signal 210 from the phase adjusting circuit 209. The selecting circuit 211 is functionally coupled to the frequency-dividing circuit 206 to receive the internal synchronization signal 205 from the frequency-dividing circuit 206. As described above, the selecting circuit 211 is configured to select, based on the phase comparison result, one of the variable-frame synchronization signal 210 and the internal synchronization signal 205 as a synchronization signal to be used for picking up images. The selecting circuit 211 is configured to select the variable-frame synchronization signal 210 as a synchronization signal to be used for picking up images, if the phase comparison result indicates that the subframe synchronization signal 202 corresponds in phase to the internal synchronization signal 205.

The camera device 200 may further include a driving circuit 212 and an image pickup element 213. The driving circuit 212 is functionally coupled to the selecting circuit 211 to receive the selected synchronization signal from the selecting circuit 211. The driving circuit 212 is functionally coupled to the image pickup element 213 to control the image pickup element 213 in accordance with the selected synchronization signal. The image pickup element 213 can be realized by, but is not limited to, a photoelectric converter.

In FIG. 2, the synchronization signal generator 100 may include, but is not limited to, a first clock generating unit, an internal synchronization signal generating unit, and a frame rate setting unit. The first clock generating unit is configured to generate a first reference clock signal. The frame rate setting unit is configured to allow setting a frame rate. The internal synchronization signal generating unit is functionally coupled to the first clock generating unit to receive the first reference clock signal from the first clock generating unit. The internal synchronization signal generating unit is functionally coupled to the frame rate setting unit to receive an output signal representing the frame rate from the frame rate setting unit. The internal synchronization signal generating unit is configured to generate, based on the output signal representing the frame rate, the subframe synchronization signal 104 and the variable-frame synchronization signal 105 from the first reference clock signal.

The first clock generating unit can be realized by, but is not limited to, an Xtal 101. The internal synchronization signal generating unit can be realized by, but is not limited to, a frequency-dividing circuit 102. The frame rate setting unit can be realized by, but is not limited to, a frame rate setting circuit 103.

Preferred examples will be described below.

The Xtal 101 is a crystal oscillator that generates the first reference clock. The first reference clock has the same output frequency as the second reference clock that serves as the system clock of the camera device 200.

The output from the Xtal 101 is frequency-divided by the frequency dividing circuit 102 that performs as the internal synchronization signal generating unit, thereby generating the subframe synchronization signal 104 and the variable-frame synchronization signal 105. The subframe synchronization signal 104 is a synchronization signal that has a fixed frame rate, for example, 30 frames per second. The variable-frame synchronization signal 105 is a synchronization signal that has a variable frame rate that can vary to correspond to a selected one of plural frame rates that have already been set by the frame rate setting unit 103. The variable-frame synchronization signal 105 is a synchronization signal having a variable frame rate that corresponds to one of a variety of frame rates that have been set by the frame rate setting unit 103. The frame rate setting unit 103 is configured to set the frame rate in accordance with operation signals that have been generated by user's operations. The user's operations may include, but are not limited to, operations to buttons, switches or rotational switches. The frame rates can be set either before or during the process for picking up images. The frame rate can be set for each frame.

The synchronization signal generating unit 100 can be connected to the camera device 200 via a connection cable that transmits the subframe synchronization signal 104 and the variable-frame synchronization signal 105 from the synchronization signal generating unit 100 to the camera device 200.

The camera device 200 receives the subframe synchronization signal 104 and the variable-frame synchronization signal 105 from the synchronization signal generating unit 100. The phase adjusting circuit 201 performs as the second phase adjusting unit. The phase adjusting circuit 201 is configured to receive the subframe synchronization signal 104 and delays the subframe synchronization signal 104, thereby generating the subframe synchronization signal 202. The subframe synchronization signal 104 can be delayed by any available delay element such as a delay line.

The voltage controllable oscillator 207 performs as the second clock generating unit. The voltage controllable oscillator 207 is configured to generate the second reference clock that corresponds to the system clock of the camera device 200. The frequency-dividing circuit 206 performs as the internal synchronization signal generating unit. The frequency-dividing circuit 206 divides the frequency of the second reference clock, thereby generating the internal synchronization signal 205.

The phase comparing circuit 203 is configured to compare the phase of the subframe synchronization signal 202 with the phase of the internal synchronization signal 205, wherein the subframe synchronization signal 202 has been generated by the phase adjusting circuit 201 and the internal synchronization signal 205 has been generated by the frequency-dividing circuit 206 to generate the phase comparison result. The phase comparing circuit 203 is configured to supply the phase comparison result to the smoothing and amplifying 204. The smoothing and amplifying 204 is configured to receive the phase comparison result from the phase comparing circuit 203. The smoothing and amplifying 204 is also configured to convert the phase comparison result into a smoothed direct current voltage. The smoothing and amplifying 204 is further configured to amplify the smoothed direct current voltage to a desired voltage level to generate an amplified signal. The smoothing and amplifying 204 is furthermore configured to the voltage controllable oscillator 207. The voltage controllable oscillator 207 is configured to receive the amplified signal from the smoothing and amplifying 204. The voltage controllable oscillator 207 is also configured to control the second reference clock that is the output from the voltage controllable oscillator 207. The control is so made so as to reduce the phase difference between the subframe synchronization signal 202 and the internal synchronization signal 205.

A set of the phase comparing circuit 203, the smoothing and amplifying 204, the voltage controllable oscillator 207, and the frequency-dividing circuit 206 constitutes a phase locked loop circuit. The phase locked loop circuit operates to reduce the phase difference between the subframe synchronization signal 202 and the internal synchronization signal 205. Namely, the phase locked loop circuit operates to match in phase between the subframe synchronization signal 202 and the internal synchronization signal 205.

FIG. 3 is a timing chart illustrating waveforms of the external subframe synchronization signal 104, and the internal subframe synchronization signal 202. FIG. 3 shows that the connection cable connecting the synchronization generator 100 to the camera system 200 causes a transmission delay of the subframe synchronization signal 104 when transmitting on the connection cable. Increasing the length of the connection cable increases a transmission time of the subframe synchronization signal 104 on the connection cable. 100 meters in length of the connection cable can, for example, cause a transmission delay of approximately 1 microsecond.

The phase adjusting circuit 201 receives the subframe synchronization signal 104 having the transmission delay that is caused by the transmission on the connection cable. The phase adjusting circuit 201 performs a function of delaying the subframe synchronization signal 104 having the transmission delay so as to add an internal process delay to the transmission delay, thereby generating the subframe synchronization signal 202 that is matched in phase to the subframe synchronization signal 104 free of the transmission delay. This means that the internal delay process performed by the phase adjusting circuit 201 compensates the transmission delay. The subframe synchronization signal 104 free of the transmission delay is a subframe synchronization signal before transmitting the transmission cable. The subframe synchronization signal 104 having the transmission delay is a subframe synchronization signal after transmitting the transmission cable.

The internal delay process by the phase adjusting circuit 201 causes that the synchronization signal generator I 00 and the camera device 200 are matched in synchronization timing at the accuracy of the reference clock. The internal delay process also causes that the synchronization signal generator 100 and the camera device 200 are also fixed in phase. The internal delay process performed by the phase adjusting circuit 201 provides the internal process delay to the subframe synchronization signal 104 having the transmission delay. The amount of the internal process delay can be adjusted by adjusting the phase of the subframe synchronization signal 202. The adjustment of the phase of the subframe synchronization signal 202 can be performed by manual operations, while displaying waveforms of the subframe synchronization signal 104 and the subframe synchronization signal 202.

The variable-frame synchronization signal 105 is generated by the synchronization signal generator 100 and then transmitted through the connection cable to the camera device 200. Similarly to the subframe synchronization signal 104, the variable-frame synchronization signal 105 having transmitted on the connection cable has a transmission delay that is caused by transmission through the connection cable. The phase adjusting circuit 209 performing as the second phase adjusting unit is configured to receive the variable-frame synchronization signal 105 that has the transmission delay. The phase adjusting circuit 209 performs a function of delaying the variable-frame synchronization signal 105 having the transmission delay so as to add an internal process delay to the transmission delay, thereby generating the variable-frame synchronization signal 210 that is matched in phase to the variable-frame synchronization signal 105 free of the transmission delay. This means that the internal delay process performed by the phase adjusting circuit 209 compensates the transmission delay. The variable-frame synchronization signal 105 free of the transmission delay is a subframe synchronization signal before transmitting the transmission cable. The variable-frame synchronization signal 105 having the transmission delay is a subframe synchronization signal after transmitting the transmission cable.

The amount of the internal process delay can be adjusted by adjusting the phase of the subframe synchronization signal 202. The adjustment of the phase of the variable-frame synchronization signal 210 can be performed by manual operations, while displaying waveforms of the variable-frame synchronization signal 105 and the variable-frame synchronization signal 210.

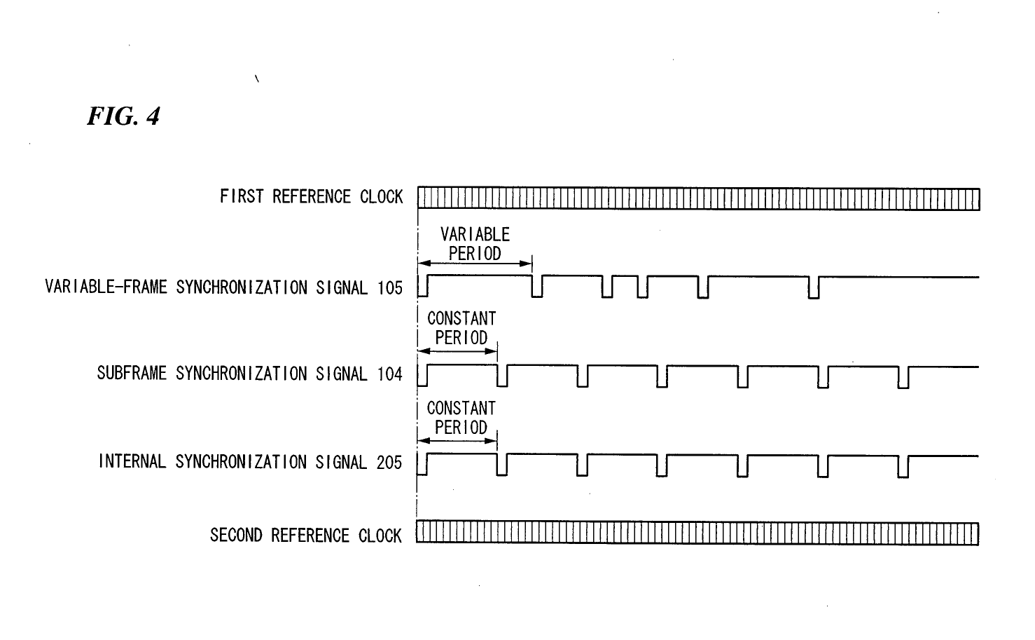

FIG. 4 is a timing chart illustrating waveforms of first and second reference clocks, the variable-frame synchronization signal 105, the subframe synchronization signal 104, and the internal synchronization signal 205. FIG. 4 shows that the operations of the above-described phase locked loop circuit causes the phase-match among the first reference clock and the subframe synchronization signal 104 in the synchronization signal generator 100 and the internal synchronization signal 205 and the second reference clock in the camera device 200. Similarly to the subframe synchronization signal 104, the variable-frame synchronization signal 105 is generated based on the first reference clock so that the variable-frame synchronization signal 105 is matched in phase to the first reference clock.

As described above, the phase adjusting circuit 209 delays the variable-frame synchronization signal 105 having the transmission delay so as to generate the variable-frame synchronization signal 210 that is matched in phase to the variable-frame synchronization signal 105 free of the transmission delay. The internal delay process performed by the phase adjusting circuit 209 causes a predetermined time difference of the start timings between the variable-frame synchronization signal 105 free of the transmission delay in the synchronization signal generator 100 and the variable-frame synchronization signal 210.

The variable-frame synchronization signal 210 and the internal synchronization signal 205 are transmitted to the selecting circuit 211 that performs as the synchronization signal selecting unit. The phase comparing circuit 203 compares the subframe synchronization signal 202 with the internal synchronization signal 205 to generate a phase lock signal 208 as the phase comparison result. The phase lock signal 208 is transmitted from the phase comparing circuit 203 to the selecting circuit 211. The phase lock signal 208 as the phase comparison result indicates whether or not the subframe synchronization signal 202 corresponds in phase to the internal synchronization signal 205. The phase lock signal 208 may be, but is not limited to, a binary digit signal. If the phase lock signal 208 as the phase comparison result indicates that the subframe synchronization signal 202 corresponds in phase to the internal synchronization signal 205, then the selecting circuit 211 selects the variable-frame synchronization signal 210 as a synchronization signal to be used for picking up images. The selected variable-frame synchronization signal 210 is then transmitted to the driving circuit 212. If the phase lock signal 208 as the phase comparison result indicates that the subframe synchronization signal 202 does not correspond in phase to the internal synchronization signal 205, then the selecting circuit 211 selects the internal synchronization signal 205 as the synchronization signal to be used for picking up images. The selected internal synchronization signal 205 is then transmitted to the driving circuit 212.

The driving circuit 212 is configured to drive the image pickup element 213. The driving circuit 212 is configured to control the image pickup element 213 based on the synchronization signal selected by the selecting circuit 211. The image pickup element 213 can be realized by a photoelectric converter. The photoelectric converter performs a photoelectric conversion that converts an incident light into electric signals as image pickup signals. If the selecting circuit 211 selects the variable-frame synchronization signal 210, then the image pickup element 213 performs a variable-frame rate image pickup operation at the start timing of the variable-frame synchronization signal 210, thereby generating image pickup signals.

The variable-frame synchronization signal generated by the synchronization signal generator 100 in the outside of the camera device 200 is used to perform an external synchronization control to the image pickup operation of the camera device 200 at the variable-frame rate.

If the synchronization signal generating unit 100 does not supply the subframe synchronization signal 104 or the variable frame synchronization signal 105 to the camera device 200, then the selecting circuit 211 selects the internal synchronization signal 205 that has been generated from the second reference clock by the frequency dividing circuit 206. The second reference clock has been generated by the voltage-controllable oscillator 207. The image pickup element 213 is driven at a predetermined frame rate, for example, of 30 frames per second.

As shown in FIG. 1, the camera device 200 is configured to transmit the input subframe synchronization signal 104 and the input variable-frame synchronization signal 105 to output ports that can be connected to a follower device.

In accordance with the above-described camera system, the phase adjustments are performed so that the subframe synchronization signal 202 and the variable frame synchronization signal 210 are matched in phase to the first reference clock, while the subframe synchronization signal 202 and the internal synchronization signal 205 are matched in phase to each other. The phase adjustments are performed so that if the phase of the internal synchronization signal 205 is matched to the phase of the subframe synchronization signal 202, then the variable-frame synchronization signal 210 is selected as the synchronization signal for the camera device 200, whereby the phase of the variable-frame synchronization signal 210 is matched or synchronized to the phase of the second reference clock. This allows that the image pickup timing of the camera device 200 is controlled externally when the image pickup operation is performed at a variable frame rate that can vary under the control of a user.

### Second Embodiment

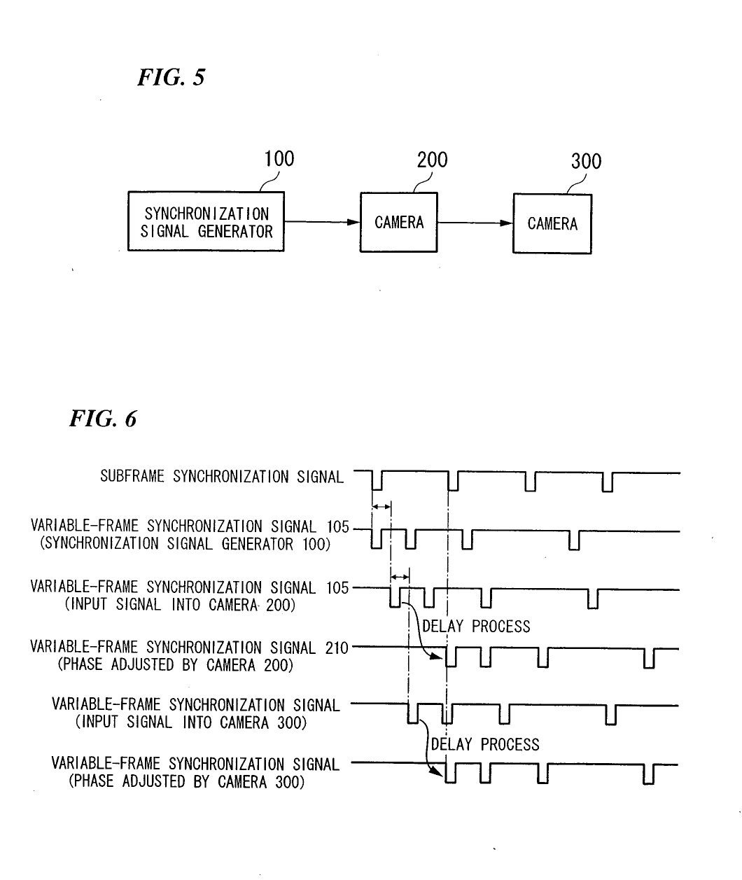

A second embodiment of the present invention will be described. The following descriptions will focus on differences of the second embodiment from the above-described first embodiment. In this embodiment, the camera system includes the synchronization signal generator 100 described above and a plurality of camera devices, for example, the camera devices 200 and 300, each of which performs to pick up images at variable frame rates under the external synchronization control. FIG. 5 is a block diagram illustrating a configuration of the camera system in accordance with the second embodiment of the present invention. As shown in FIG. 5, the camera devices 200 and 300 are connected in series to the synchronization signal generator 100 through connection cables. The camera devices 200 and 300 have the same configuration. As shown in FIG. 1, the synchronization signal generator 100 generates the subframe synchronization signal 104 and the variable-frame synchronization signal 105. The subframe synchronization signal 104 and the variable-frame synchronization signal 105 are input into the camera device 200 and then output from the camera device 200 without being processed.

The output subframe synchronization signal 104 and the output variable-frame synchronization signal 105 are further transmitted from the camera device 200 to the camera device 300 through the connection cable. In the camera device 300, the subframe synchronization signal 104 is then input into the phase adjusting circuit 201. The phase adjustment performed by the phase adjusting circuit 201 compensates the transmission delay caused by the transmission on the connection cable between the cameras 200 and 300. The phase locked loop circuit operates to phase-match the above-described synchronization signals and the reference clocks in the synchronization signal generator 100 and the camera devices 200 and 300.

Increasing the number of the camera devices that are connected in series causes increasing the transmission delay of the variable-frame synchronization signal transmitting on the connection cables. In each of the camera devices, the phase adjustment of the variable-frame synchronization signal is performed based on the phase delay timing of the variable-frame synchronization signal, wherein the phase delay is performed by the phase adjusting circuit 209 in the camera device on the final stage, thereby matching the start timings of the variable frame synchronization signals in the respective camera devices.

For example, the two camera devices 200 and 300 are connected in series to the synchronization signal generator 100 as shown in FIG. 5. FIG. 6 is a timing chart illustrating waveforms of the subframe synchronization signal, the variable-frame synchronization signal 105 in the synchronization signal generator 100, the variable-frame synchronization signal 105 input into the camera 200, the variable-frame synchronization signal 210 in the camera device 200, the variable-frame synchronization signal input into the camera device 300, and the variable-frame synchronization signal in the camera device 300.

As shown in FIG. 6, the variable-frame synchronization signal 105 input into the camera 200 has a transmission delay. The variable-frame synchronization signal 210 in the camera device 200 has a delay caused by the phase delay process performed by the phase adjusting circuit 209 in the camera device 200. The variable-frame synchronization signal input into the camera device 300 has another transmission delay that is larger than the above transmission delay of the variable-frame synchronization signal 105 input into the camera 200. The variable-frame synchronization signal in the camera device 300 has another delay caused by the phase delay process performed by the phase adjusting circuit 209 in the camera device 300. The phase adjusting circuit 209 in the camera device 200 and the phase adjusting circuit 209 in the camera device 300 perform delay adjustments so that the variable-frame synchronization signal 210 in the camera device 200 is matched in phase to the variable-frame synchronization signal in the camera device 300.

In each of the camera devices, the phase adjusting circuit 209 performs the phase adjustments so that a delay of the variable-frame synchronization signal input into each camera device is equal to the largest one of the delays of the variable-frame synchronization signals that have been inputted into the camera devices.

The plural camera devices are controlled externally and accurately. Simple routing of the connection cables need to unidirectionally transmit the subframe synchronization signal and the variable-frame synchronization signal through the series connection of the plural cameras from the synchronization signal generator 100.

### Third Embodiment

A third embodiment of the present invention will be described. The following descriptions will focus on differences of the third embodiment from the above-described first embodiment. In this embodiment, the camera system includes a synchronization signal generator 400 and a plurality of camera devices, for example, the camera devices 500, 600 and 700, each of which performs to pick up images at variable frame rates under the external synchronization control.

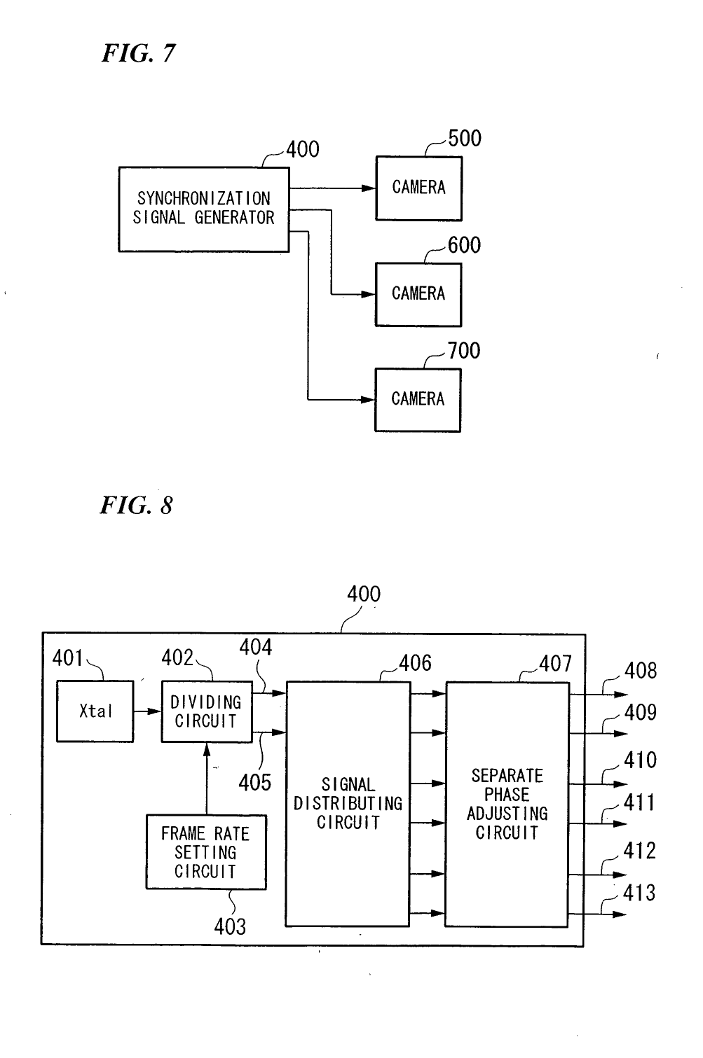

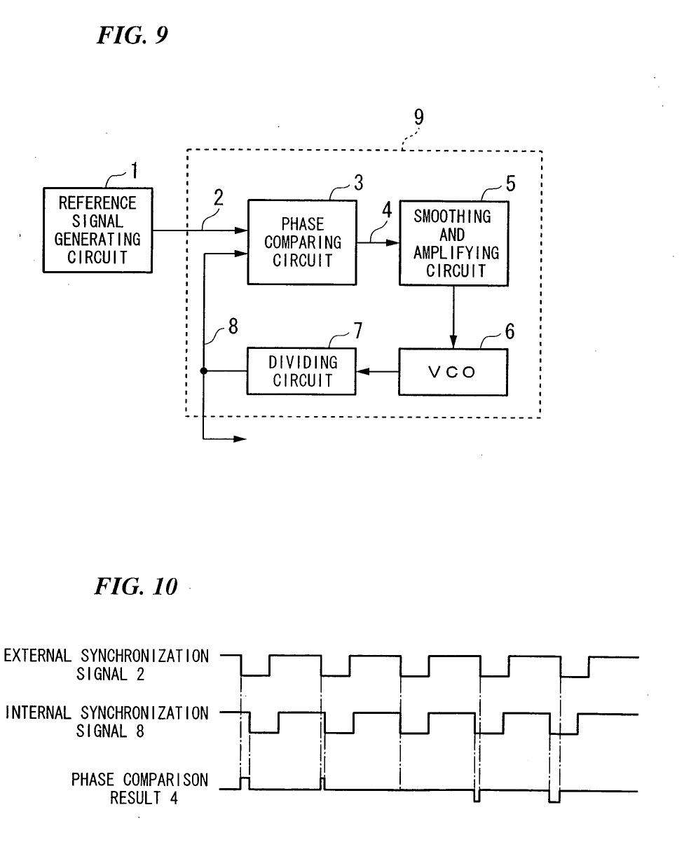

FIG. 7 is a block diagram illustrating a configuration of the camera system in accordance with the third embodiment of the present invention. As shown in FIG. 7, the camera devices 500, 600 and 700 are connected in parallel to the synchronization signal generator 400 through connection cables. The camera devices 500, 600 and 700 have the same configuration as the above-described camera device 200 of the first embodiment. The synchronization signal generator 400 has a different configuration from that of the synchronization signal generator 100 shown in FIG. 2.

FIG. 8 is a block diagram illustrating a configuration of the synchronization signal generator 400 included in the camera system shown in FIG. 7. The synchronization signal generator 400 includes an Xtal 401, a frequency dividing circuit 402, a frame rate setting circuit 403, a signal distributing circuit 406, and a separate phase adjusting circuit 407.

The Xtal 401 is a crystal oscillator that generates a first reference clock that has the same output frequency as and a similar frequency variation property to the second reference clock as the system clock for each of the camera devices. The frequency-dividing circuit 402 is functionally coupled to the Xtal 401 to receive the first reference clock from the Xtal 401. The frequency-dividing circuit 402 is also functionally coupled to the frame rate setting circuit 403 to receive a variety of frame rates that has been set by the frame rate setting circuit 403. The frame rate setting circuit 403 is configured to divide the frequency of the first reference clock to generate a subframe synchronization signal 404 and a variable-frame synchronization signal 405. The subframe synchronization signal 404 is a synchronization signal that has a fixed frame rate which may, for example, be, but is not limited to, 30 frames per second. The variable-frame synchronization signal 405 is a synchronization signal that has a variable frame rate which corresponds to one of the frame rates having been set by the frame rate setting circuit 403.

The signal distributing circuit 406 is functionally coupled to the frequency-dividing circuit 402 to receive the subframe synchronization signal 404 and the variable-frame synchronization signal 405 from the frequency-dividing circuit 402. The signal distributing circuit 406 is configured to copy or duplicate a set of the subframe synchronization signal 404 and the variable-frame synchronization signal 405 to prepare plural sets of the subframe synchronization signal 404 and the variable-frame synchronization signal 405. If the external synchronization control to the three camera devices 500, 600, and 700 is performed to pick up images at variable frame rates, then the signal distributing circuit 406 copies or duplicates a set of the subframe synchronization signal 404 and the variable-frame synchronization signal 405 to prepare three sets thereof for the three camera devices 500, 600, and 700, respectively.

The separate phase adjusting circuit 407 performs as a separate phase adjusting unit. The separate phase adjusting circuit 407 is functionally coupled to the signal distributing circuit 406 to receive the plural sets of the subframe synchronization signal 404 and the variable-frame synchronization signal 405 from the signal distributing circuit 406. The separate phase adjusting circuit 407 is configured to perform separate phase adjustments of each set of the subframe synchronization signal 404 and the variable-frame synchronization signal 405. The phase adjustments of one set of the subframe synchronization signal 404 and the variable-frame synchronization signal 405 is separate from the phase adjustments of other sets. The separate phase adjusting circuit 407 is configured to perform the separate phase adjustments so as to compensate respective transmission delays that depend on respective lengths of transmission cables that connect the three camera devices 500, 600, and 700 to the synchronization signal generator 400. The provision of the separate phase adjusting circuit 407 in the synchronization signal generator 400 allows each of the camera devices 500, 600, and 700 to be free of the phase adjusting circuits 201 and 209 that are shown in FIG. 1.

The separate phase adjustments means that the separate phase adjusting circuit 407 adjusts a phase difference between the subframe synchronization signal 404 and the variable-frame synchronization signal 405 for each of the camera devices 500, 600, and 700. The separate phase adjusting circuit 407 adjusts a phase difference between the subframe synchronization signal 404 and the variable-frame synchronization signal 405 which make a first set, thereby generating a subframe synchronization signal 408 and a variable-frame synchronization signal 409. The separate phase adjusting circuit 407 supplies the subframe synchronization signal 408 and the variable-frame synchronization signal 409 to the camera device 500. The separate phase adjusting circuit 407 adjusts a phase difference between the subframe synchronization signal 404 and the variable-frame synchronization signal 405 which make a second set, thereby generating a subframe synchronization signal 410 and a variable-frame synchronization signal 411. The separate phase adjusting circuit 407 supplies the subframe synchronization signal 410 and the variable-frame synchronization signal 411 to the camera device 600. The separate phase adjusting circuit 407 adjusts a phase difference between the subframe synchronization signal 404 and the variable-frame synchronization signal 405 which make a third set, thereby generating a subframe synchronization signal 412 and a variable-frame synchronization signal 413. The separate phase adjusting circuit 407 supplies the subframe synchronization signal 412 and the variable-frame synchronization signal 413 to the camera device 700.

The above-described configuration of the camera system allows the synchronization signal generator 400 to perform the external synchronization control to match the timings of picking up images at the variable frame rates among the camera devices 500, 600, and 700.

The external synchronization control to the plural camera devices is available. The above-described parallel connections of the camera devices 500, 600, and 700 with reference to the synchronization signal generator 400 is suitable to suppress the transmission delay from increasing.

The provision of the separate phase adjusting circuit 407 in the synchronization signal generator 400 allows each of the camera devices 500, 600, and 700 to be free of the phase adjusting circuits 201 and 209 that are shown in FIG. 1. This configuration is suitable to reduce the manufacturing cost for each camera device.

It is possible as a modification to replace the synchronization signal generator 400 by the synchronization signal generator 100 that is free of any phase adjusting circuit, provided that each of the camera devices 500, 600, and 700 includes the set of the phase adjusting circuits 201 and 209 shown in FIG. 1.

It is also possible as a modification to change the number of the camera devices included in the camera system.

In accordance with the first to third embodiments, the camera system performs the phase adjustment so as to match the phase of the variable-frame synchronization signal with the phase of the second reference clock. If the camera performs the operation of picking up images at a variable frame rate that varies by user's operations, then the external synchronization control can be made to control the timings of picking up images.

The term “unit” is used to describe a component, section or part of a device includes hardware and/or software that is constructed and/or programmed to carry out the desired function. A typical example of the hardware may include, but is not limited to, circuits.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A camera system comprising:
a synchronization signal generator further comprising:
a first clock generating unit configured to generate a first reference clock signal; and
an internal synchronization signal generating unit configured to divide a frequency of the first reference clock signal, the internal synchronization signal generating unit being configured to generate a subframe synchronization signal having a constant period and a variable-frame synchronization signal having a variable period, and
a camera device further comprising:
a second clock generating unit configured to generate a second reference clock signal;
an internal synchronization signal generating unit configured to divide a frequency of the second reference clock signal, the internal synchronization signal generating unit being configured to generate an internal synchronization signal;
a first phase adjusting unit configured to adjust at least one of a phase of the second reference clock signal and a phase of the internal synchronization signal so that the subframe synchronization signal corresponds in phase to the internal synchronization signal; and
a synchronization signal selecting unit configured to select the variable-frame synchronization signal as a synchronization signal to be used for picking up an image if the subframe synchronization signal corresponds in phase to the internal synchronization signal.

2. The camera system according to claim 1, wherein the first phase adjusting unit comprises:
a phase comparing circuit that compares a phase of the subframe synchronization signal with a phase of the internal synchronization signal; and
a smoothing and amplifying circuit that converts an output from the phase comparing circuit into a smoothed direct current voltage signal, the smoothing and amplifying circuit amplifying the smoothed direct current voltage signal, and
wherein the second clock generating unit comprises:
a voltage controllable oscillator being controlled by an output signal from the smoothing and amplifying circuit.

3. The camera system according to claim 1, wherein the synchronization signal generator is a single synchronization signal generator and the camera device is a plurality of camera devices, and
wherein each of the plurality of camera devices further comprises:
a second phase adjusting unit configured to adjust a phase difference between the subframe synchronization signal and the variable-frame synchronization signal.

4. The camera system according to claim 3, wherein the second phase adjusting unit included in one of the plurality of camera devices is configured to adjust the phase difference so that a delay of the variable-frame synchronization signal that has been input into the one of the plurality of camera devices is equal to the largest one of the delays of the variable-frame synchronization signals that have been input into the plurality of camera devices.

5. The camera system according to claim 1, wherein the synchronization signal generator is a single synchronization signal generator and the camera device is a plurality of camera devices, and
wherein the camera system further comprises:
a separate phase adjusting unit configured to adjust a phase difference between the subframe synchronization signal and the variable-frame synchronization signal for each of the plurality of camera devices separately, the separate phase adjusting unit being configured to supply the adjusted phase difference to each of the plurality of camera devices separately.

6. A camera system comprising:
a synchronization signal generator that generates a subframe synchronization signal having a constant period and a variable-frame synchronization signal having a variable period; and
a camera device being separated from the synchronization signal generator, the camera device further comprising:
an internal synchronization signal generating unit that generates an internal synchronization signal;
a phase adjusting unit that adjusts a phase of the internal synchronization signal so as to match a phase the subframe synchronization signal with a phase of the internal synchronization signal; and
a synchronization signal selecting unit that selects the variable-frame synchronization signal as a synchronization signal to be used for picking up an image if the subframe synchronization signal corresponds in phase to the internal synchronization signal.
